(19) United States
(12) Patent Application Publication
(10) Pub. No.: US 2010/0318334 A1
(43) Pub. Date: Dec. 16, 2010

(54) DATA ANALYSIS APPARATUS, DATA ANALYSIS METHOD, AND PROGRAM

(75) Inventor: Michinari Momma, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, Tokyo (JP)

(21) Appl. No.: 12/866,828

(22) PCT Filed: Feb. 9, 2009
(86) PCT No.: PCT/JP2009/052132

§ 371 Date: Aug. 9, 2010

(30) Foreign Application Priority Data
Feb. 7, 2008 (JP) 2008-027775

(51) Int. Cl. G06G 7/48

(52) U.S. Cl. 703/6

(57) ABSTRACT

The data analysis apparatus (100) of the present invention includes a control unit (180) that, upon input of a plurality of data that are the object of analysis, sets constraints that take as version space a space that is enclosed by planes that contain these data and moreover that are perpendicular to each of the plurality of data in model parameter space, maximizes the size of a shape that is inscribed in a plurality of planes that enclose the version space, and finds the center of the shape.

### TECHNICAL FIELD

The present invention relates to data analysis apparatus and a data analysis method for constructing models for classification problems and regression problems and to a program for causing a computer to execute this method.

2. Background Art

An example of a support vector machine (hereinbelow abbreviated as SVM) is disclosed in U.S. Pat. No. 5,649,068 (hereinbelow referred to as Document 1). A data analysis apparatus that is capable of executing SVM is described. A case of handling a 2-class classification problem is here described.

FIG. 1 is a block diagram showing an example of the configuration of a related data analysis apparatus. As shown in FIG. 1, data analysis apparatus 200 includes memory unit 230 for storing analysis-object data that are data that are the object of analysis, and control unit 210 that seeks hyperplanes by means of a predetermined procedure. Control unit 210 is provided with a CPU (Central Processing Unit) (not shown), and the CPU executes a predetermined process in accordance with a program. In the program, a computation method is described in advance for a quadratic programming problem computation.

One example of the formulation of an SVM is disclosed in “New support vector algorithms” by B. Scholkopf, A. J. Smola, R. C. Williamson, and P. L. Barlett in Neural Computation, 12: 1207-1245, (2000) (hereinbelow referred to as Document 2).

The operation of data analysis apparatus 200 shown in FIG. 1 is next described. FIG. 2 is a figure for explaining the operation of the data analysis apparatus shown in FIG. 1.

When teaching data in which two classes are labeled are applied as the analysis-object data input, control unit 210 stores the teaching data in memory unit 230. The black circles and white circles shown in FIG. 2 correspond to data points that are points showing data of different classes. Control unit 210 next uses the teaching data stored in memory unit 230 to calculate the separation planes that maximize the distance between classes (margin). This calculation is formulated as a quadratic programming problem, and control unit 210 carries out a numerical calculation by this formulation. When finding the classification hyperplane shown in FIG. 2, a formula showing the classification hyperplane is supplied by way of a display device (not shown in the figure).

FIG. 2 shows a case in which noise is not contained in the data, but typically, noise is frequently contained in data as shown in FIG. 3. In the case shown in FIG. 3, slack variable ζ is inserted as the value of error and formulation is carried out that takes the tradeoff of margin maximization and the sum.

In the case of a multiclass problem, a problem is divided into a plurality of two-class problems to calculate a plurality of separation planes (hyperplanes) and classification is then carried out by a combination of these separation planes.

Alternatively, a nonlinear model can be constructed as shown below by converting data using mapping of data to different space, and typically using mapping to a higher dimension. Because a dual problem of a quadratic programming problem is written by only the inner product of data that have been mapped, defining the inner product of data as a kernel function enables all computation and model construction. Defining a kernel function eliminates the need to positively define mapping and can therefore provide mapping of infinite dimensions by a closed function. This method is referred to as a kernel trick.

On the other hand, techniques regarding model construction methods that use version space are described in the following Documents 3 to 5. Document 3 is “Beyes point machines” by Ralf Herbrich, Thore Graepel, and Colin Campbell in Journal of Machine Learning Research, 1:245-279, 2001. Document 4 is “Playing billiards in version space” by P. Rujan in Neural Computation, 9:99-122, 1997. Document 5 is “An analytic center machine” by Theodore B. Trafalis and Alexander M. Malyscheff in Machine Learning, 46, 203-223, 2002.

Version space is the region in model parameter space in which all teaching data are correctly learned. Beyes points are the center points in which hyperplanes that divide space into two equal portions overlap at points within version space. Beyes points have superior generalization capabilities. Documents 3 and 4 describe the approximation of these Beyes points by the center of mass in version space. Document 5 describes approximation by analytic centers.

### DISCLOSURE OF THE INVENTION

When seeking hyperplanes from analysis-object data, the problem arises that approximation by only typical SVM yields rough results, and the generalization capability is therefore poorer than a classifier that uses Beyes points.

On the other hand, when using a Beyes point machine (BPM) that finds points that more accurately approximate Beyes points, the problem arises that the algorithm is more difficult to handle than SVM. This problem arises because a BPM seeks center of mass from billiard sampling in version space, whereby the convergence speed in high-dimension space is not theoretically guaranteed, and in addition, attaching meanings to parameters and formulization that permits errors as in SVM is problematic.

In the analytic centers of Document 5, the theoretical and intuitive understanding of the degree to which Beyes points are approximated is difficult. In addition, tolerance of error and attaching meanings to parameters are also problematic.

An exemplary object of the present invention is to provide a data analysis apparatus and data analysis method that maintain the utility of SVM and that enable analysis of higher accuracy, and further, to provide a program that causes a computer to execute the program.

A data analysis apparatus according to an exemplary aspect of the present invention includes a control unit that: upon the input of a plurality of data that are the object of analysis, sets constraints that take as version space a space that is enclosed by planes that contain these data and moreover that are perpendicular to normal vectors for each of the plurality of data in model parameter space; maximizes the size of the shape that is inscribed in the plurality of planes that enclose the version space; and finds the center of the shape.

In addition, a data analysis method according to an exemplary aspect of the present invention includes steps of: upon the input of a plurality of data that are the object of analysis, setting constraints that take as version space a space that is enclosed by planes that contain the data and moreover that are perpendicular to normal vectors for each of the plurality of data in a model parameter space; maximizing the size of the shape that is inscribed in the plurality of planes that enclose the version space; and finding the center of the shape.

Finally, a program according to an exemplary aspect of the present invention is a program for causing a computer to execute processes of: upon the input of a plurality of data that are the object of analysis, setting constraints that take as version space a space that is enclosed by planes that contain these data and moreover that are perpendicular to normal vectors for each of the plurality of data in model parameter space; maximizing the size of shape that is inscribed in the plurality of planes that enclose the version space; and finding the center of the shape.

### BRIEF DESCRIPTION OF THE DRAWINGS

FIG. 1 is a block diagram showing an example of the configuration of a related data analysis apparatus;

FIG. 2 is a view for explaining the operation of the data analysis apparatus shown in FIG. 1;

FIG. 3 is a view for explaining the operation of the data analysis apparatus shown in FIG. 1;

FIG. 4 is a block diagram showing an example of the configuration of a data analysis apparatus according to the present exemplary embodiment;

FIG. 5 is a view for explaining the control unit shown in FIG. 4;

FIG. 6 is a flow chart showing the procedures of the data analysis apparatus of the present exemplary embodiment;

FIG. 7 shows an example of a polygon that represents version space in two dimensions;

FIG. 8 shows another example of a polygon that represents version space in two dimensions;

FIG. 9 shows an example of a shape that is inscribed in the polygon shown in FIG. 8; and

FIG. 10 is a block diagram showing an example that uses the data analysis apparatus of the present exemplary embodiment in an SVM system.

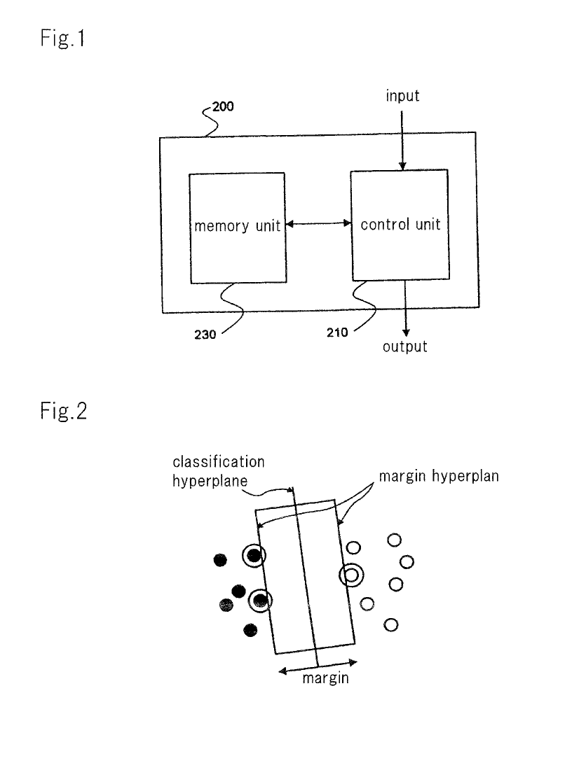

### EXPLANATION OF REFERENCE

100 data analysis apparatus
130 memory unit
180 control unit
400 network

### BEST MODE FOR CARRYING OUT THE INVENTION

The configuration of a data analysis apparatus of the present exemplary embodiment is next described. FIG. 4 is a block diagram showing an example of the configuration of the data analysis apparatus of the present exemplary embodiment.

As shown in FIG. 4, data analysis apparatus 100 includes memory unit 130 and control unit 180. Control unit 180 includes a CPU (not shown) that executes processing in accordance with a program and memory (not shown) for storing the program.

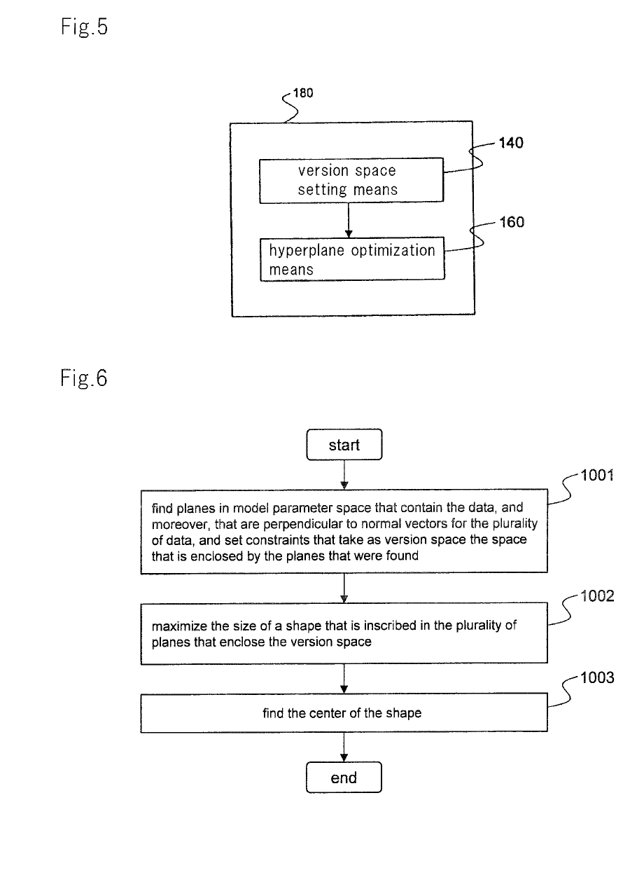

FIG. 5 is a view for explaining the control unit shown in FIG. 4. As shown in FIG. 5, control unit 180 includes version space setting means 140 and hyperplane optimization means 160. Version space setting means 140 and hyperplane optimization means 160 are realized virtually in data analysis apparatus 100 by the execution of the program by the CPU.

The analysis tasks that are the objects of processing of data analysis apparatus 100 include, for example, classification problems, regression problems, and outlier estimation problems. All of these problems involve finding estimated values of labels for input data.

In the case of a classification problem, a label is a class label (such as symbol values or integer values having no order) or a real-number value showing the degree of affiliation to the label. In the case of a regression problem, a label is a real-number value. In the case of an outlier estimation problem, a label is an outlier score.

Information of formulas and data for calculation by control unit 180 are stored in advance in memory unit 130. Analysis-object data that are received as input from outside are also stored in memory unit 130. Still further, data in the process of computation and the results of computation are also stored in memory unit 130.

Version space setting means 140 sets, as a constraint, version space for a plurality analysis-object data in model parameter space. Details regarding the method of setting version space will be described hereinbelow. Hyperplane optimization means 160 maximizes a shape that is inscribed in a plurality of planes that enclose version space and finds the center of this shape. At this time, hyperplane optimization means 160 executes the construction of a nonlinear model using a kernel trick and nonlinear convex programming problem calculation based on SVM.

The computation method executed by each means is described in advance in a program, and necessary data are stored in memory unit 130.

The flow of all processing of data analysis apparatus 100 of the present exemplary embodiment is next described. FIG. 6 is a flow chart showing the procedure of the data analysis apparatus of the present exemplary embodiment.

Upon input of a plurality of data as analysis-object data, control unit 180 stores these data in memory unit 130. Control unit 180 next finds planes in model parameter space that contain the data, and moreover, that are perpendicular to normal vectors for the plurality of data, and sets constraints that take as version space the space that is enclosed by the planes that were found (Step 1001). Control unit 180 then maximizes the size of a shape that is inscribed in the plurality of planes that enclose the version space (Step 1002) and finds the center of the shape (Step 1003). Finding this center is equivalent to finding formulas that show hyperplanes.

The processing realized by data analysis apparatus 100 of the present exemplary embodiment is next described in detail. Here, the analysis task is assumed to be a 2-class classification problem. Because the analysis method of a 2-class classification problem can be expanded to a 1-class or multiclass classification or to a regression problem, a detailed explanation of these forms is here omitted.

A method of formulation by means of a typical SVM is first described.

As analysis-object data, m items of data xᵢ of n (where n is an integer equal to or greater than 2) dimensions and their labels yᵢ (−1 or 1) are applied as input.

[Formula 1]

xᵢεRⁿ,yᵢεR,i=1 . . . m (1)

In addition, the size of xᵢ is assumed to be “1.”

[Formula 2]

∥xᵢ∥=1 (2)

The following data matrix is a matrix that takes data points as row vectors:

[Formula 3]

X=[x₁ . . . xₘ]^{T} (3)

A maximization problem is next formulated as follows. Here, using the SVM formulation described in Document 2 leads to the following maximization problem:

$$[ Formula 4 ]$$

$$\begin{matrix}\begin{matrix}max & ρ \\ s . t . & \frac{{y}_{i} ( {x}_{i}^{T} w + b )}{{‖ {x}_{i} ‖}_{2}} = {y}_{i} ( {x}_{i}^{T} w + b ) \geq ρ , i = 1 … m \\ & {‖ w ‖}_{2} \leq 1 ,\end{matrix} \} \\ [ Formula 5 ] & ( 4 ) \\ {x}_{i}^{T} w + b & ( 5 )\end{matrix}$$

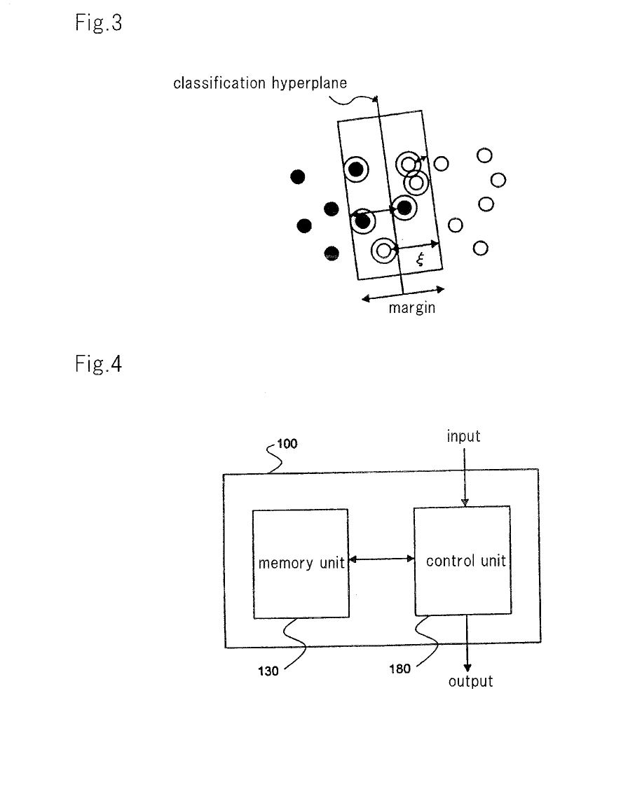

Formula 5 is estimation by means of a model, and if the product of this estimation and the label is positive, the estimation is correct. Formula 4 can also be interpreted as the maximization of the margin of FIG. 2. Slack variable ζ is introduced to allow for error contained in the data. Points that are realized by the equality of the inequality constraint of Formula 4 are called support vectors. Of the data points of FIG. 2 and FIG. 3, data points that are enclosed in circles correspond to support vectors.

$$[ Formula 6 ]$$

$$\begin{matrix}min & - m ρ + \frac{1}{v} {\sum }_{i = 1}^{m} {ξ}_{i} \\ s . t . & {y}_{i} ( {x}_{i}^{T} w + b ) \geq ρ - {ξ}_{i} , i = 1 , … , m \\ & {‖ w ‖}_{2} \leq 1\end{matrix} \} \qquad ( 6 )$$

Formula 6 is an SVM maximization problem referred to as ν SVM.

If the normal vector of the hyperplane shown in FIG. 2 and FIG. 3 is w, FIG. 2 and FIG. 3 are figures in which each item of data is a point vector and the normal vector ν of a hyperplane is a direction vector.

Regarding FIG. 2 and FIG. 3 in the present exemplary embodiment, version space setting means 140 takes the point vector of each item of data as a normal vector and was a point vector. When the point vector of each item of data is taken as a normal vector, the plane that is perpendicular to each normal vector is considered. When the polyhedron that is enclosed by these planes is formed, the interior of this polyhedron is version space that is the space in which all constraints are satisfied. Version space setting means 140 thus sets version space as the constraint.

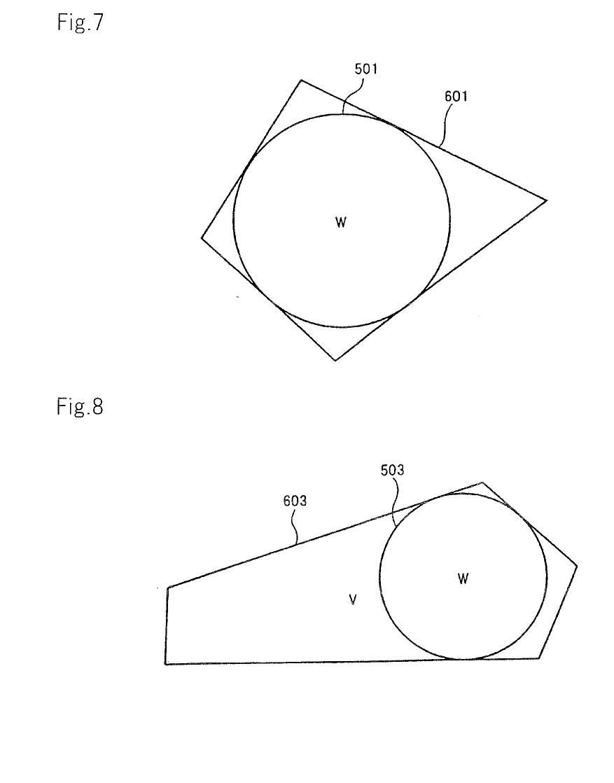

FIG. 7 and FIG. 8 are figures showing examples of polygons that represent version space in two dimensions. For the sake of explanation, the figures show the case of a plane and the polyhedrons are shown as polygons.

In Formula 4 or Formula 6:

$$[ Formula 7 ]$$

$$\begin{matrix}\frac{{y}_{i} ( {x}_{i}^{T} w + b )}{{‖ {x}_{i} ‖}_{2}} \\ [ Formula 8 ] & ( 7 ) \\ {y}_{i} ( {x}_{i}^{T} w + b ) & ( 8 )\end{matrix}$$

Formula 7 is the distance (considered without b) between point vector w and the planes indicated by Formula 8. In other words, Formulas 4 and 6 are the problem of maximizing the minimum value of the distance between point vector w and the planes of the constraints. This is similar to the problem of finding the maximization of the volume of a sphere inscribed in a polyhedron. In other words, hyperplane optimization means 160 finds the approximate point of a Beyes point by finding the center of the maximum inscribed sphere in version space.

In the case of the example shown in FIG. 7, point vector w that is the center of maximum inscribed circle 501 of polygon 601 (corresponding to a sphere of a polyhedron) can be estimated to approximate a Beyes point with comparative accuracy. However, in the case of the example shown in FIG. 8, point vector w that is the center of maximum inscribed circle 503 of polygon 603 is found as a point of a position that is offset in version space. As a result, the accuracy of approximation with Beyes point V is poor.

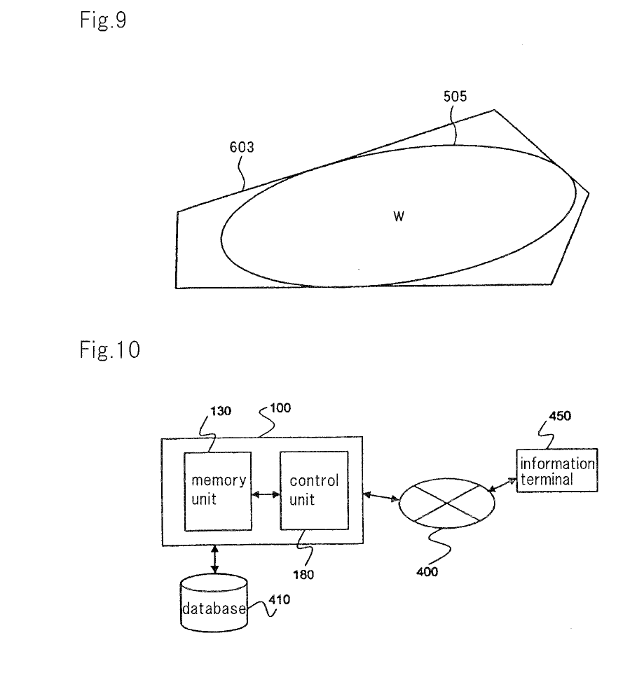

In the present exemplary embodiment, however, an ellipsoid or a higher-order convex body is used as the shape that is inscribed in version space to improve the accuracy of approximation with a Beyes point. A higher-order convex body is a convex body in which, with respect to a quadratic ellipse, the parameters are quartic. The following explanation regards an ellipsoid (shown by an ellipse in the figure). FIG. 9 shows an example for a case in which the shape inscribed in polygon 603 is ellipse 505.

Hyperplane optimization means 160 carries out a process as shown next. An ellipsoid that takes point vector was a center is represented by parameters as shown below.

[Formula 9]

ε={Bu+w|∥u∥2≦1,B [symbol] 0}. (9)

Applying this formula to the constraint of Formula 6 yields:

[Formula 10]

yᵢ(xᵢ^{T}(Bu+w)+b)≧ρ−ξi,∀u,∥u∥2≦1 (10)

This is the condition in which point vector w is the center of the inscribed ellipsoid of a polyhedron. This condition holds for all u, and therefore holds for the worst case when u=−x. Accordingly:

[Formula 11]

yᵢ(xᵢ^{T}w+b)−xᵢ^{T}Bxᵢ≧ρ−ξᵢ, (11)

can also be assumed.

The volume of an ellipsoid:

is known to be proportional to Formula 12:

[Formula 12]

det B (12)

and the following formulation is carried out to find the approximate point of the Beyes point of version space by maximizing Formula 12 to maximize the volume of an ellipsoid, or in other words, by using the maximum inscribed ellipsoid.

$$[ Formula 13 ]$$

$$\begin{matrix}min & - C log det B - m ρ + \frac{1}{v} {e}^{T} ξ \\ s . t . & {y}_{i} ( {x}_{i}^{T} w + b ) - {x}_{i}^{T} {Bx}_{i} \geq ρ - {ξ}_{i} \\ & {‖ w ‖}_{2} \leq 1 \\ & ξ \geq 0 ,\end{matrix} \} \qquad ( 13 )$$

Here, C is a tradeoff constant that adjusts maximization of volume and the degree of tolerance of error. The model that is found by solving this formula is referred to as ellipsoidal SVM (ESVM).

Hyperplane optimization means 160 next gives the following change to stabilize numerical computation.

$$[ Formula 14 ]$$

$$\begin{matrix}min & - C ( r log det B - ( 1 - r ) trace B ) - m ρ + \frac{1}{v} {e}^{T} ξ \\ s . t . & {y}_{i} ( {x}_{i}^{T} w + b ) - {x}_{i}^{T} {Bx}_{i} \geq ρ - {ξ}_{i} \\ & {‖ w ‖}_{2} \leq 1 \\ & ξ \geq 0.\end{matrix} \} \qquad ( 14 )$$

Here, r is a tradeoff constant.

[Formula 15]

traceB (15)

The newly added term (Formula 15) gives the cost that causes B to approach unit matrix I. This has a normalizing effect. The value of r can change the importance of the term that causes B to approach I. In addition, prior knowledge is stored in advance in memory unit 130, and if the value (B0), that B is to approach, is known, formulation is carried out as follows:

$$[ Formula 16 ]$$

$$\begin{matrix}min & - C ( r log det {BB}_{0}^{- 1} - ( 1 - r ) trace {BB}_{0}^{- 1} ) - m ρ + \frac{1}{v} {e}^{T} ξ \\ s . t . & {y}_{i} ( {x}_{i}^{T} w + b ) - {x}_{i}^{T} {Bx}_{i} \geq ρ - {ξ}_{i} \\ & {‖ w ‖}_{2} \leq 1 \\ & ξ \geq 0 ,\end{matrix} \} \qquad ( 16 )$$

Hyperplane optimization means 160 next kernelizes Formula 16 to build a nonlinear model. The Lagrangian of Formula 14 is as follows:

$$[ Formula 17 ]$$

$$\begin{matrix}\begin{matrix}ℒ & = & - C ( r log det B - ( 1 - r ) trace B ) + \frac{1}{v} {e}^{T} ξ - m ρ \\ & & - {\sum }_{i} {α}_{i} ( {y}_{i} ( {x}_{i}^{T} w + b ) - {x}_{i}^{T} {Bx}_{i} + ρ - {ξ}_{i} ) \\ & & + β ( {‖ w ‖}_{2}^{2} - 1 ) - γρ - {δ}^{T} ξ ,\end{matrix} \} \\ [ Formula 18 ] & ( 17 ) \\ \begin{matrix}max & Cr log det {B}^{- 1} - \frac{1}{4 β} {α}^{T} diag ( y ) {XX}^{T} diag ( y ) α - β \\ s . t . & {B}^{- 1} = \frac{1}{τ} ( ( 1 - r ) I + \frac{1}{C} {X}^{T} diag ( α ) X ) \\ & {y}^{T} α = 0 , 0 \leq α \leq \frac{1}{v} e , {e}^{T} α \geq m , β < 0\end{matrix} \} & ( 18 )\end{matrix}$$

A dual problem is given below using KKT (Karush-Kuhn-Tucker) conditions.

$$[ Formula 19 ]$$

$$\begin{matrix}max & Cr log det {B}^{- 1} - τ - β \\ s . t . & {‖ \begin{matrix}{X}^{T} diag ( y ) α \\ β - τ\end{matrix} ‖}_{2} \leq β + τ \\ & {B}^{- 1} = \frac{1}{r} ( ( 1 - r ) I + \frac{1}{C} {X}^{T} diag ( α ) X ) \\ & {y}^{T} α = 0 , 0 \leq α \leq \frac{1}{v} e , {e}^{T} α \geq m , β \geq 0\end{matrix} \} \qquad ( 19 )$$

Writing the second term of the object function as a quadratic cone condition, and

using conversion realized by the kernel of Formula 20:

[Formula 2]

x [symbol] Φ(x), or X X^{T} [symbol] K, (20)

to abbreviate constant terms leads to the following problem:

$$[ Formula 21 ]$$

$$\begin{matrix}max & r log det ( ( 1 - r ) I + \frac{1}{C} {K}^{1 / 2} diag ( α ) {K}^{1 / {2}^{T}} ) - τ - β \\ s . t . & ‖ \begin{matrix}{K}^{1 / 2} diag ( y ) α \\ β - τ\end{matrix} ‖ \leq β + τ \\ & {y}^{T} α = 0 , 0 \leq α \leq \frac{1}{v} e , {e}^{T} α \geq m , β \geq 0.\end{matrix} \} \qquad ( 21 )$$

Formula 21 is a convex nonlinear programming problem having a quadratic cone condition and can be solved using a method such as a gradient method. Hyperplane optimization means 160 uses Formula 22:

$$[ Formula 22 ]$$

$$ω = \frac{1}{2 β} {X}^{T} diag ( y ) α \qquad ( 22 )$$

as an estimation value to calculate:

$$[ Formula 23 ]$$

$$f ( x ) = \frac{1}{2 β} {\sum }_{i = 1}^{m} k ( {x}_{i} , x ) {α}_{i} + b \qquad ( 23 )$$

This is the formula that shows the hyperplane that is sought.

As shown hereinabove, hyperplane optimization means 160 constructs a kernel from the analysis-object data, collects information such as parameters, and shapes to a form that can be handled by nonlinear convex programming problem computation. A number of methods can be considered for implementing nonlinear convex programming problem computation. Implemented methods include a method of applying a general-purpose library of positive semidefinites, a solving method that solves by dividing Formula 21 into small problems such as by chunking, and a gradient method that, even when small problems are optimized, uses a library and is customized to Formula 21.

An example is here described here of a method to solve the problem by dividing the problem into smaller problems. The following problem is considered:

$$[ Formula 24 ]$$

$$\begin{matrix}max & rC log det ( \begin{matrix}( 1 - r ) I + \\ \frac{1}{C} Z diag ( α ) {Z}^{T}\end{matrix} ) - \frac{1}{4 β} {α}^{T} YKY α - β \\ s . t . & {y}^{T} α = 0 , 0 \leq α \leq \frac{1}{v} e , {e}^{T} α \geq m , β \geq 0.\end{matrix} \} \qquad ( 24 )$$

Formula 24 is a nonlinear convex programming problem relating to α, β, and γ.

The KKT conditions are first given. The Lagrangian can be written as:

$$[ Formula 25 ]$$

$$\begin{matrix}ℒ = & - rC log det ( \begin{matrix}( 1 - r ) I + \\ \frac{1}{C} Z diag ( α ) {Z}^{T}\end{matrix} ) + \frac{1}{4 β} {α}^{T} YKY α + β \\ & - γ {y}^{T} α - π ( {e}^{T} α - m ) - {δ}^{T} α + {μ}^{T} ( α - \frac{1}{v} e ) - λβ .\end{matrix} \} \qquad ( 25 )$$

The necessary condition of optimization is that the differential of the Lagrangian becomes 0. Differentiating by a yields:

$$[ Formula 26 ]$$

$$\begin{matrix}\frac{\partial ℒ}{\partial {α}_{i}} = \frac{1}{2 β} {y}_{i} {\sum }_{j} {K}_{ij} {y}_{j} {α}_{j} - \\ {{z}_{i}^{T} ( \frac{( 1 - r )}{r} I + \frac{1}{rC} Z diag ( α ) {Z}^{T} )}^{- 1} {z}_{i} - \\ γ {y}_{i} - π - {δ}_{i} + {μ}_{i} \\ = ( {G}_{i} - γ ) {y}_{i} - π - {δ}_{i} + {μ}_{i} - {z}_{i}^{T} \tilde{B} {z}_{i} \\ = ( {H}_{i} - γ ) {y}_{i} - π - {δ}_{i} + {μ}_{i} \\ = 0 ,\end{matrix} \qquad ( 26 )$$

Here, the following definitions apply:

$$[ Formula 27 ]$$

$$\begin{matrix}\begin{matrix}{G}_{i} = \frac{1}{2 β} \sum {K}_{ij} {y}_{j} {α}_{j} \\ \tilde{B} = {( ( 1 - r ) / rI + \frac{1}{rC} Z diag ( α ) {Z}^{T} )}^{- 1}\end{matrix} \} \\ [ Formula 28 ] & ( 27 ) \\ {H}_{i} = \frac{1}{2 β} {\sum }_{j} {K}_{ij} {y}_{j} {α}_{j} - {y}_{i} {z}_{i}^{T} \tilde{B} {z}_{i} & ( 28 )\end{matrix}$$

When compared with the method disclosed in the document “Improvements to Platt's SMO algorithm for SVM classifier design” by S. S. Keerthi et. al in Neural Computation (2001), attention is given to the addition of the term B.

$$[ Formula 29 ]$$

$$\begin{matrix}{α}_{i} = 0 & {δ}_{i} > 0 , {μ}_{i} = 0 ⇒ ( {H}_{i} - γ ) {y}_{i} - π \geq 0 \\ 0 < {α}_{i} < 1 / v & {δ}_{i} = 0 , {μ}_{i} = 0 ⇒ ( {H}_{i} - γ ) {y}_{i} - π = 0 \\ {α}_{i} = 1 / v & {δ}_{i} = 0 , {μ}_{i} > 0 ⇒ ( {H}_{i} - γ ) {y}_{i} - π \leq 0\end{matrix} \} \qquad ( 29 )$$

Using these conditions, data that do not satisfy the conditions are intensively optimized and an optimization solution is found by repeating this process.

One example of a method of SVM optimization is Sequential Minimal Optimization (SMO), and this method is used here.

Using B to write the object function produces:

$$[ Formula 30 ]$$

$$\begin{matrix}U ( α ) & = & rC log det ( \begin{matrix}( 1 - r ) I + \\ \frac{1}{C} Z diag ( α ) {Z}^{T}\end{matrix} ) - \frac{1}{4 β} {α}^{T} YKY α - β \\ & = & rC log det {\tilde{B}}^{- 1} + mr log r - \frac{1}{4 β} {α}^{T} YKY α - β\end{matrix} \} \qquad ( 30 )$$

The second term is abbreviated because m and r are constants.

In SMO, only two variables a are moved while satisfying the following conditions to find the optimal value in this two-variable problem, and the global solution is found by repeating this process.

$$[ Formula 31 ]$$

$${y}^{T} α = 0 , 0 \leq α \leq \frac{1}{v} e , {e}^{T} α \geq m \qquad ( 31 )$$

Accordingly, the following update is considered to satisfy the first condition.

[Formula 32]

α^{new}=α^{old}+s(eᵢ−yᵢyⱼeⱼ) (32)

Here, s is the step size.

When the third condition is considered, s is subject to the following constraint:

$$[ Formula 33 ]$$

$$s \geq \frac{1}{2} ( m - {e}^{T} {α}^{old} ) \qquad ( 33 )$$

The method of satisfying the second condition is the same as SMO.

A two-variable problem is derived. Using the α updating formula (Formula 32) and a matrix determinant lemma yields:

$$[ Formula 34 ]$$

$$\begin{matrix}log det {\tilde{B}}^{- 1} = log det ( ( 1 - r ) / rI + \frac{1}{rC} Z diag ( α ) {Z}^{T} ) \\ = log det ( ( 1 - r ) / rI + \frac{1}{rC} ( {\sum }_{i} {α}_{i}^{old} {z}_{i} {z}_{i}^{T} ) + \frac{s}{rC} ( {z}_{i} {z}_{i}^{T} - {y}_{i} {y}_{j} {z}_{j} {z}_{j}^{T} ) ) \\ = log det ( \tilde{{B}^{{old}^{- 1}}} + \frac{s}{rC} ( {z}_{i} {z}_{i}^{T} - {y}_{i} {y}_{j} {z}_{j} {z}_{j}^{T} ) ) \\ = log det ( \tilde{{B}^{{old}^{- 1}}} + \frac{s}{rC} [ \begin{matrix}{z}_{i} & {z}_{j}\end{matrix} ] [ \begin{matrix}1 & 0 \\ 0 & - {y}_{i} {y}_{j}\end{matrix} ] [ \begin{matrix}{z}_{i}^{T} \\ {z}_{j}^{T}\end{matrix} ] ) \\ = log det ( rCI + s [ \begin{matrix}{z}_{i}^{T} \\ {z}_{j}^{T}\end{matrix} ] \tilde{{B}^{old}} [ \begin{matrix}{z}_{i} & {z}_{j}\end{matrix} ] [ \begin{matrix}1 & 0 \\ 0 & - {y}_{i} {y}_{j}\end{matrix} ] ) + const \\ = log det ( [ \begin{matrix}rC + s {ω}_{ii} & - {sy}_{i} {y}_{j} {ω}_{ij} \\ s {ω}_{ij} & rC - {sy}_{i} {y}_{j} {ω}_{jj}\end{matrix} ] ) + const ,\end{matrix} \qquad ( 34 )$$

Here, ωᵢⱼ is defined as:

[Formula 35]

ωᵢⱼ=zᵢ^{T}\tilde{B}^{old}zᵢ (35)

Formula 34 takes the logarithm of a two-dimensional determinant and can be easily computed. The reason why it is necessary to have a constraint in which the determinant is positive, when seeking optimal s, can therefore be understood.

Seeking the differential realized by s of Formula 30 results in:

$$[ Formula 36 ]$$

$$\begin{matrix}\frac{\partial U ( α )}{\partial s} = rC \frac{\partial log det {\tilde{B}}^{- 1}}{\partial s} - \frac{\partial }{\partial s} ( \frac{1}{4 β} {α}^{T} YKY α ) \\ = \frac{1}{f ( s )} ( ( {rCa}_{1} - {a}_{0} {a}_{3} ) + ( 2 {rCa}_{2} - {a}_{1} {a}_{3} - {a}_{0} {a}_{4} ) s - ( {a}_{2} {a}_{3} + {a}_{1} {a}_{4} ) {s}^{2} - {a}_{2} {a}_{4} {s}^{3} ) )\end{matrix} \qquad ( 36 )$$

Here, parameters from a₀ to a₄ are given as follows:

$$[ Formula 37 ]$$

$$\begin{matrix}{a}_{0} & = & {r}^{2} {C}^{2} \\ {a}_{1} & = & rC ( {ω}_{ii} - {y}_{i} {y}_{j} {ω}_{jj} ) \\ {a}_{2} & = & {y}_{i} {y}_{j} ( {ω}_{ij}^{2} - {ω}_{ii} {ω}_{jj} ) \\ {a}_{3} & = & \frac{{y}_{i} ( {G}_{i} - {G}_{j} )}{2 β} \\ {a}_{4} & = & \frac{{K}_{ii} + {K}_{ii} - 2 {K}_{ij}}{2 β}\end{matrix} \} \qquad ( 37 )$$

Formula 36 for finding the optimum step size s is a cubic equation, and the analysis solution is thus found. This solution is used to execute SMO.

The algorithms are:

0. Initial value α (and β) are given as appropriate to satisfy the constraint of Formula 31.

1. The step size s for points at which Formula 29 of the KKT conditions is not satisfied based on current α is found by solving Formula 36. The constraint for α that is updated at this time is satisfied (a quadratic condition in which the terms in the log of Formula 34 in addition to Formula 31 and Formula 33 are positive).

2. Satisfaction of KKT conditions is determined for all data. When the conditions are not satisfied, the process returns to 1.

After nonlinear convex programming problem computation has been carried out by any of the above-described methods, hyperplane optimization means 160 saves the results such as α, β, b, and the kernel parameters shown in Formula 23 in memory unit 130 and displays the results by a display device (not shown).

According to the present exemplary embodiment, the volume of a shape inscribed in version space that is set as a constraint in model parameter space is maximized, and the center of this shape is found to derive the formula of a hyperplane. Expanding and applying SVM to setting parameter enables maintaining of SVM operability, achieving a greater reduction of the computational load than BPM, and finding of a hyperplane that contains points that are approximated by Beyes points.

### Working Example 1

The present working example applies the data analysis apparatus of the present exemplary embodiment to an SVM system. There are many examples of the use of SVM, such as text classification, pharmacological activity classification, handwriting classification, fault detection, and unauthorized business transaction detection. The data analysis apparatus of the present exemplary embodiment improves accuracy by expanding SVM and therefore can be applied to all problems that can use SVM.

The configuration of the system of the present working example is next described. FIG. 10 is a block diagram showing an example of the configuration of the system of the present working example.

As shown in FIG. 10, database 410 for constructing models is connected to data analysis apparatus 100. Data analysis apparatus 100 and database 410 are provided in an ASP (Application Service Provider). Data analysis apparatus 100 is connected to network 400 such as the Internet. Information terminal 450 provided on the user's side of the system is also connected to network 400.

In addition to the functions described using FIG. 4 and FIG. 5, data analysis apparatus 100 is also provided with the capability by which control unit 180 transmits and receives data with information terminal 450 by way of network 400. The method of transmitting and receiving data accords with TCP/IP (Transmission Control Protocol/Internet Protocol) and detailed explanation is therefore here omitted.

After construction of a model, control unit 180 receives new data that correspond to this model from information terminal 450, analyzes the new data according to the model, and then transmits the results of this analysis by way of network 400 to information terminal 450.

Analysis-object data for computing hyperplanes are stored in database 410. The analysis-object data are teaching data realized by analyzing real data by an operator. The operator defines attributes in advance regarding the object of investigation and labels the data to generate the teaching data.

When the classes of the objects of analysis are numerous as described hereinabove, a plurality of analysis-object data occur for each class, whereby voluminous memory capacity is necessary to store data. As a result, database 410 is provided separate from memory unit 130 in the present working example, but all of the analysis-object data may also be saved in memory unit 130.

Information terminal 450 is an information processing device such as a personal computer or workstation. The user operates information terminal 450 to transmit new data to data analysis apparatus 100 and causes data analysis apparatus 100 to analyze the data.

The operating procedure of the system of the present working example is next described. For the sake of explanation, a case is described in which the object of analysis is a single class.

Data analysis apparatus 100 uses analysis-object data that are stored in database 410 to find a hyperplane formula and construct a model as described in the exemplary embodiment. After constructing a model, data analysis apparatus 100 receives new data corresponding to the model from information terminal 450 and then analyzes the new data according to the model. Data analysis apparatus 100 then transmits the analysis results by way of network 400 to information terminal 450. Information terminal 450, upon receiving the analysis results from data analysis apparatus 100, displays the analysis results on a display unit (not shown).

According to the present working example, users desiring a data analysis service can be provided with the service at any time and at any place provided that it is possible to connect to a network using an information processing terminal.

As an example of the effect of the present invention, a model in which points, through which hyperplanes pass and which more closely approximate Beyes points, can be constructed with greater precision than a method realized by a typical SVM.

While the invention has been particularly shown and described with reference to an exemplary embodiment and a working example thereof, the invention is not limited to the above-described embodiment and working example. It will be understood by those of ordinary skill in the art that various changes in faun and details may be made therein without departing from the spirit and scope of the present invention as defined by the claims.

This application is based upon and claims the benefit of priority from Japanese Patent Application No. 2008-027775 filed on Feb. 7, 2008, the content of which is incorporated by reference.

1. A data analysis apparatus that, upon input of teaching data to which attributes and labels have been added in advance, creates a model for classifying said teaching data into two categories, said data analysis apparatus comprising:
a memory unit to store said teaching data;
version space setting unit that sets constraints for forming version space that is space in which category classification without error is possible for each of said teaching data in model parameter space formed by parameters that represent said model; and
hyperplane optimization unit that finds said parameters that maximize the size of a shape that is inscribed in a plurality of planes that form said version space, and that takes said shape that is maximized as said model.

2. The data analysis apparatus according to claim 1, wherein said shape is a convex body, an ellipse or an ellipsoid.

3. The data analysis apparatus according to claim 1, wherein said hyperplane optimization unit, when maximizing the size of said shape, applies to setting said parameters an ellipsoidal support vector machine that introduces maximization of said shape and a tolerance value of error.

4. A data analysis apparatus that, upon input of new data to which said model is applied, uses a model created by said data analysis apparatus according to claim 1 to classify said new data into a plurality of categories and displays results of classifications on a display device.

5. A data analysis method by a data analysis apparatus that, upon input of teaching data to which attributes and labels have been added in advance, creates a model for classifying said teaching data into two categories, said data analysis method comprising steps of:
upon input of said teaching data, setting constraints for forming version space that is space in which category classification without error is possible for each of said teaching data in model parameter space formed by parameters that represent said model; and
finding said parameters that maximize the size of a shape that is inscribed in a plurality of planes that form said version space and taking said shape that is maximized as said model.

6. The data analysis method according to claim 5, wherein said shape is a convex body, an ellipse, or an ellipsoid.

7. The data analysis method according to claim 5, wherein when maximizing the size of said shape, an ellipsoidal support vector machine that introduces maximization of said shape and a tolerance value of error, is applied to setting said parameters.

8. A data analysis method wherein, upon input of new data to which said model is applied, a model created by said data analysis method according to claim 5 is used to classify said new data into a plurality of categories and results of classifications are displayed on a display device.

9. A program product for causing a computer that, upon input of teaching data to which attributes and labels have been added in advance, creates a model for classifying said teaching data into two categories, to execute processes of:
upon input of said teaching data, setting constraints for forming version space that is space in which category classification without error is possible for each of said teaching data in model parameter space formed by parameters that represent said model; and
finding said parameters that maximize the size of a shape that is inscribed in a plurality of planes that form said version space and taking said shape that is maximized as said model.

10. The program product according to claim 9, wherein said shape is a convex body, an ellipse, or an ellipsoid.

11. The program product according to claim 9, wherein when maximizing the size of said shape, an ellipsoidal support vector machine that introduces maximization of said shape and a tolerance value of error, is applied to setting said parameters.

12. The program product that further comprises processes of, upon input of new data to which said model is applied, classifying said new data into a plurality of categories by using a model created by an execution of said program according to claim 9, and displaying results of classifications on a display device.
